(19) United States
(12) Patent Application Publication
(10) Pub. No.: US 2009/0090794 A1
(43) Pub. Date: Apr. 9, 2009

(54) LOW PRESSURE FUEL INJECTOR

(75) Inventors: David Ling-Shun Hung, Novi, MI (US); Vivek A. Jairazbhoy, Farmington Hills, MI (US); David L. Porter, Westland, MI (US)

Correspondence Address: DICKINSON WRIGHT PLLC, 1875 Eye Street, NW, Suite 1200, WASHINGTON, DC, 20006, US

(73) Assignee: Visteon Global Technologies, Inc., Van Buren Township, MI (US)

(21) Appl. No.: 11/867,393

(22) Filed: Oct. 4, 2007

(51) Int. Cl. F02M 69/04

(52) U.S. Cl. 239/533.2

(57) ABSTRACT

A low pressure fuel injector capable of atomizing fuel at relatively low pressure is configured to have reduced hydraulic resistance. Reduction in the hydraulic resistance minimizes the pressure drop within the fuel injector and thereby improves atomization of the fuel for improved fuel economy and performance, and decreased emissions.

### BACKGROUND OF THE INVENTION

1. Technical Field

This present invention is directed to fuel injectors for automotive engines and, more particularly, to fuel injectors capable of atomizing fuel at relatively low pressures.

2. Discussion

Fuel injected internal combustion engines are well known in the industry. In direct injected engines, the injection tip of the fuel injector extends into the combustion chamber and includes a perforated plate also known as a metering plate for dispersing and directing fuel from the injection valve. In a conventional gasoline engine with port fuel injection system, the injection tip of the injector extends into a cavity or rail of the engine's intake manifold where the injected fuel is mixed with intake air before being discharged into the engine's combustion chamber.

A metering plate located on the end of the fuel injector includes a variety of fuel flow passages that are configured to provide extremely small fuel droplets to meet stringent emission standards for internal combustion engines. The fine atomization of the fuel reduces exhaust emissions and improves cold weather start capabilities as well as reduces fuel consumption and improves performance. Typically the optimization of the droplet size depends on the pressure of the fuel and requires high pressure delivery of roughly 7 to 10 MPa. However, a higher fuel delivery pressure causes greater dissipation of the fuel and propagates the fuel further outward from the injector which makes it more likely that fuel condenses on the walls of the cylinder and on the top surface of the piston thereby decreasing the efficiency of combustion and increasing emissions.

To address these problems, fuel injector systems have been proposed which utilize low pressure fuel while at the same time providing sufficient atomization of the fuel. To generate sufficient atomization at such low pressure, fuel injectors typically employ sharp edges at the nozzle orifice for atomization and acceleration of the fuel. However, the relatively low pressure of the fuel and sharp edges result in the spray being difficult to direct and reduces the range of the spray. More particularly, the spray angle or cone angle produced by the injector is somewhat more narrow. At the same time, additional improvement to the atomization of the low pressure fuel injector would increase the efficiency and operation of the engine.

### SUMMARY OF THE INVENTION

In view of the above, the present invention is directed to a low pressure fuel injector capable of atomizing fuel at relatively low pressure is configured to have reduced hydraulic resistance. Reduction in the hydraulic resistance minimizes the pressure drop within the fuel injector and thereby improves atomization of the fuel for improved fuel economy and performance, and decreased emissions.

The fuel injector generally includes a valve needle having at least one surface with an elongated portion extending approximately parallel to a longitudinal axis, and a valve seat defining a valve passage extending along the longitudinal axis and wherein the valve seat defines an inner surface having a first arcuate portion with a profile of an arcuate curve extending from approximate parallel alignment with the longitudinal axis toward the longitudinal axis.

The arcuate portion has a portion approximately perpendicular to the longitudinal axis. A transition portion extends from the first arcuate portion and approximately perpendicular to the longitudinal axis, and the transition portion further extends to a second arcuate portion wherein the second arcuate portion includes a seal area for sealing engagement with the needle valve. More specifically, the second arcuate portion extends along an arcuate curve arranged approximately perpendicular to the longitudinal axis toward a nozzle outlet edge along a surface angled approximately between fifteen degrees and seventy five degrees from parallel with the longitudinal axis.

The first arcuate portion is configured to not contact the valve needle. The needle valve includes a lower planar surface approximately perpendicular to the longitudinal axis, and wherein the at least one surface is an approximately planar surface aligned along the longitudinal axis.

The present invention is directed to a low pressure fuel injector for delivering fuel to a cylinder of an engine having a valve needle having an approximately planar surface extending approximately parallel to a longitudinal axis and a lower surface being approximately planar and extending approximately perpendicular to the longitudinal axis.

The present invention is directed to a low pressure fuel injector for delivering fuel to a cylinder of an engine, the fuel injector having a valve seat defining a valve passage extending along the longitudinal axis and wherein the valve seat defines an inner surface having a first arcuate portion having a profile of an arcuate curve extending from approximate parallel alignment with the longitudinal axis toward the longitudinal axis, and a second arcuate portion having a substantially opposing arcuate curve.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a cross-sectional view of a prior art low pressure fuel injector;

FIG. 2 is a cross-sectional view of a low pressure fuel injector constructed in accordance with the teachings of the present invention;

FIG. 3 is a cross-sectional view of a low pressure fuel injector constructed in accordance with the teachings of the present invention; and

FIG. 4 is a perspective view of the valve needle.

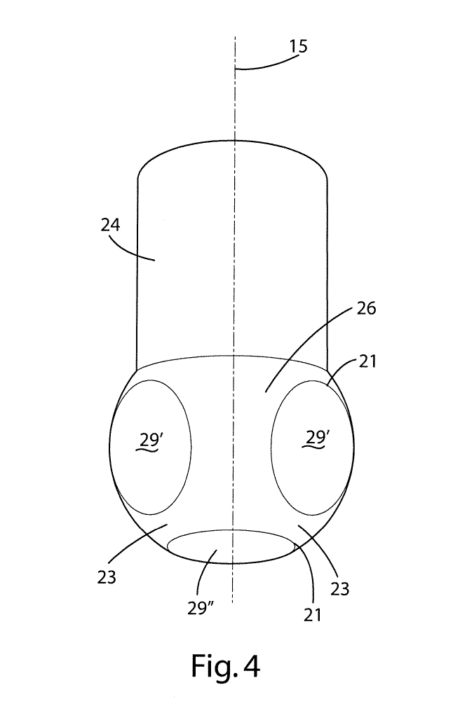

### DETAILED DESCRIPTION OF THE PREFERRED EMBODIMENT

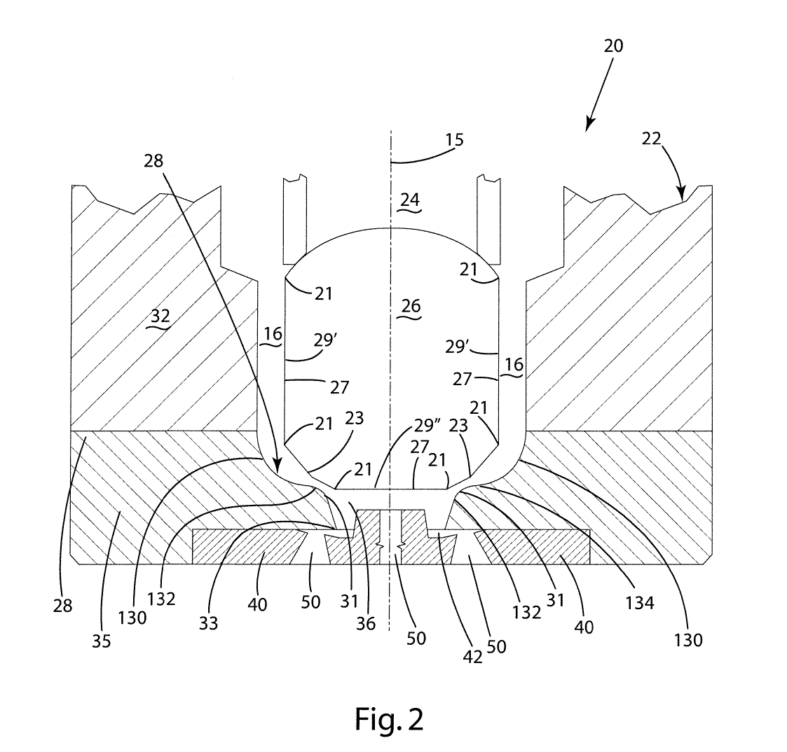

A low pressure fuel injector 20 is generally illustrated in a partial cross-sectional view in FIG. 2. The injector 20 is used to deliver fuel to a cylinder of an engine, such as an internal combustion engine of a vehicle. An injector body 22 defines a passageway 24 and located within the passageway 24 and capable of engaging a valve seat 28 is a needle 26. The needle 26 cooperates with the valve seat 28 to form a needle valve to start and stop fluid flow through the injector 20. The injector body 22 is generally aligned along a longitudinal axis 15 and the passageway 24 generally extends along or parallel to the longitudinal axis 15. A lower end of the injector body 22 defines a nozzle body 32. It should be recognized by those skilled in the art that the injector body 22 and nozzle body 32 may be formed separately or the nozzle body 32 may be attached to the distal end of the injector body 22 by welding or other known techniques.

In either case, the nozzle body 32 defines a valve seat 28 leading to a valve outlet 36 of the needle valve. The needle 26 is generally moved along the longitudinal axis 15, in and out of engagement with the valve seat 28, and is usually controlled by an electromagnetic actuator (not shown). In this manner, fluid or fuel flowing through the internal passage 24 and around the needle 26 is permitted or prevented from flowing to the valve outlet 36 by engagement or disengagement of the needle 26 with the valve seat 28.

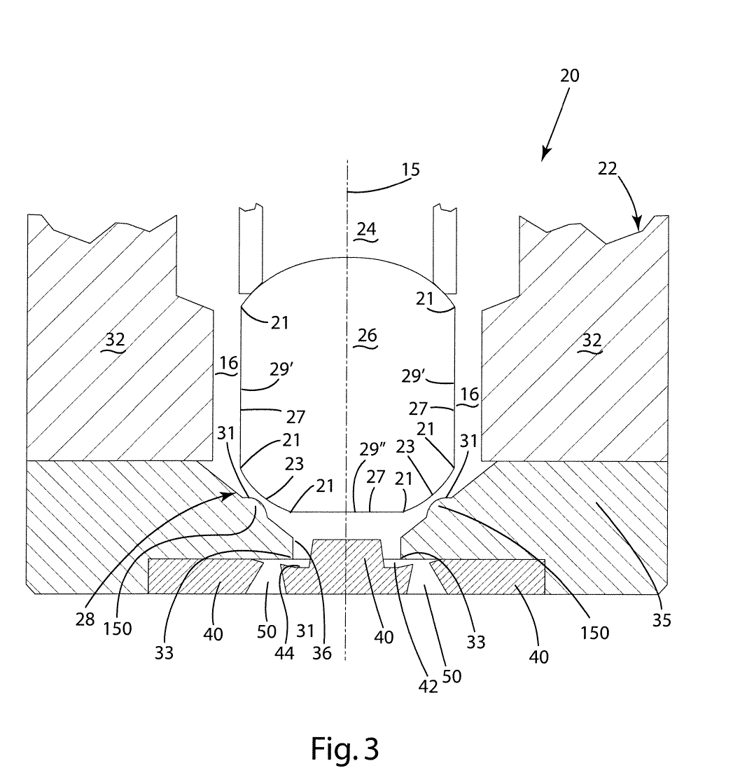

The injector 20 further includes a metering plate 40 which is attached to the nozzle body 32. It should be recognized by those skilled in the art that the metering plate 40 may be integrally formed with the nozzle body 32 or separately formed and attached to the nozzle body 32 by welding or other known techniques. In either case, the metering plate defines a nozzle cavity 42 for receiving fuel from the valve outlet 36. The nozzle cavity 42 may be generally defined by the metering plate 40 and the lower portion of the nozzle body 32, which also defines at least a portion of the valve outlet 36. As illustrated in FIGS. 2 and 3, the metering plate 40 defines a nozzle cavity 42 which is defined by at least a bottom wall 44. In some embodiments, although not illustrated, the metering plate may further include a side wall with the nozzle cavity 42 taking on a wide variety of configurations. The metering plate 40 further includes exit cavities 50. The exit cavities 50 may be formed in a variety of size, shapes, and configurations. The location of the exit cavities may depend upon the desired spray pattern formed by the metering plate 40. The exit cavities 50 may be formed in a variety of sizes, shapes, and configurations.

In addition to using the location, size, shape, and configuration of the exit cavities as well as sharp edges that the nozzle orifice includes, the present invention uses the contours and configuration of the needle valve and valve seat to reduce the hydraulic resistance in the valve passageway, which reduces the pressure drop caused by the passageway, which in turn allows for high turbulence of the fuel to improve atomization of the fuel in the cylinder thereby decreasing emissions while increasing performance and fuel economy.

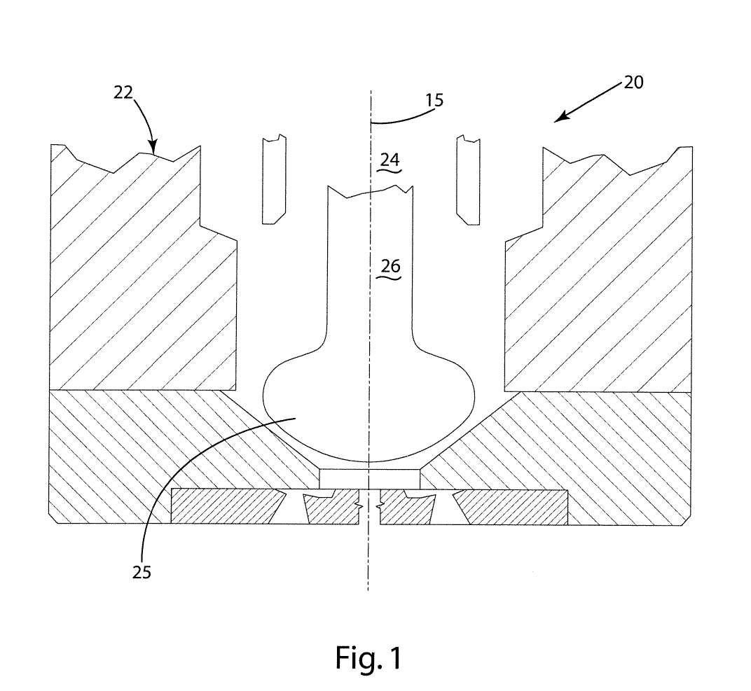

As part of the present invention, reduce hydraulic resistance and to enhance turbulence and thereby improve atomization of the fuel, the needle valve is formed with at least two planar surfaces 27, preferably three planar surfaces, and more preferably at least four planar surfaces. The number of planar surfaces may vary depending upon the configuration of the passageway as well as the desired flow of the fuel. As illustrated in the prior art illustration of FIG. 1, needles 26 have generally a bulbous end 25. In comparison, as illustrated in FIGS. 2 and 3, the present invention not only includes planar side surfaces 29′ but a planar lower surface 29″ which is also substantially planar. The planar surfaces 27 on the needle 26 are bounded by edges 21. As illustrated in FIGS. 2 and 3, the needle 26 may further include transition points or transition edges 21 used to help increase the turbulence of the fuel flow. These transition points or edges 21 act in a similar manner as the sharp nozzle edge 33 used in the prior art. The edges 21 are configured to create upstream turbulence from the sharp nozzle edge 33. Increasing turbulence of the fuel stream before reaching the sharp nozzle edge 33 increases atomization of the fuel. While all of the planar surfaces 27 and lower surface 29 are illustrated as being substantially planar, they may be formed with some variation from being planar. For example, some form of a convex or concave shape that is still approximately planar may be used.

The valve seat when viewed in cross section includes a first arcuate shape 130, a second arcuate shape 132, and a transition area 134 therebetween. The first arcuate shape 130 has a radius or curved profile similar to the radius or profile of the transition portion 23 on the needle 26. As illustrated in FIG. 2, the valve seat 28 and needle 26 as well as the nozzle body 32 and needle 26 work in conjunction to form a fluid passageway 16 at the end of the passage 24. This fluid passage as it nears the lower portion 35 of the nozzle body 32 narrows. This narrowing occurs as the fluid passage 16 curves inward following the shape of the first arcuate shape 130 as illustrated in FIG. 2. The passage 16 then narrows further as the transition portion 134 extends inward almost perpendicular to the longitudinal axis 15 or at a rate much greater than the transitional portion 23 on the needle 26 extends inward. Therefore, as the fluid passage 16 narrows, it passes the edge 21 which creates turbulence and is forced into a narrower area between the second arcuate shape 132 and transition portion 23 or the needle 26. Along the second arcuate shape 132, the needle 26 contacts the valve seat 28. This point of contact is labeled as the seal area 31. In proximity to the seal area 31, the fluid passageway 16 is at its narrowest point. As the fluid passes through the passageway 16 proximate to the seal point 31 it suddenly expands into the valve outlet 36, an area of greater volume. Therefore, as the fluid flows through the passageway 16 past one of the transition points 21, it is squeezed by the first arcuate shape 130 and transition area 134 toward the seal point 31 on the second arcuate shape 132 and then expanded into the valve outlet 36. The turbulence of the fluid is increased through this design and the abrupt edges, which in turn helps with atomization of the fuel. The fuel is then squeezed past the shape nozzle edge 33 to exit one of the exit cavities 50. In the present invention the sharp nozzle edge 33 is configured to have the fuel from the passage turn along a greater radius than normal as the second arcuate shape 132 is configured to continue sloping inward toward the longitudinal axis 15 to terminate at the sharp nozzle edge 33. A lower end of the injector body 22 defines a nozzle body 32. It should be recognized by those skilled in the art that the injector body 22 and nozzle body 32 may be formed separately or the nozzle body 32 may be attached to the distal end of the injector body 22 by welding or other known techniques. The arcuate shapes, 130,132 are designed to minimize hydraulic resistance, thereby minimizing the pressure drop caused by the hydraulic resistance. Minimizing the pressure drops allows for enhancement of turbulence, thereby improving the atomization of the fuel.

The valve seat or lower nozzle body may be formed from an inverted frusto-conical shape with the inner surface of the valve seat including a ridge 150 extending around the perimeter of the valve seat, as illustrated in FIG. 3. The ridge 150 includes the seal point, which sealingly engages the needle 26 to stop the flow of fluid through the fuel injector. The ridge 150 is configured to create turbulence upstream from the nozzle point as the fluid within the passage 16 is forced through the narrower area between the ridge 150 and the needle 26 and then expands into an open area of the valve outlet.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A low pressure fuel injector for delivering fuel to a cylinder of an engine, the fuel injector comprising:
a valve needle having at least one surface with an elongated portion extending approximately parallel to a longitudinal axis; and
a valve seat defining a valve passage extending along said longitudinal axis and wherein said valve seat defines an inner surface having a first arcuate portion with a profile of an arcuate curve extending from approximate parallel alignment with said longitudinal axis toward said longitudinal axis.

2. The fuel injector of claim 1 wherein said arcuate portion has a portion approximately perpendicular to said longitudinal axis.

3. The fuel injector of claim 1 further including a transition portion extending from said first arcuate portion and approximately perpendicular to said longitudinal axis.

4. The fuel injector of claim 1 further including a second arcuate portion wherein said second arcuate portion includes a seal area for sealing engagement with said needle valve.

5. The fuel injector of claim 1 wherein said second arcuate portion extends along an arcuate curve arranged approximately perpendicular to said longitudinal axis toward a nozzle outlet edge along a surface angled approximately between fifteen degrees and seventy five degrees from parallel with said longitudinal axis.

6. The fuel injector of claim 1 wherein said first arcuate portion does not contact said valve needle.

7. The fuel injector of claim 1 wherein said needle valve includes a lower planar surface approximately perpendicular to said longitudinal axis.

8. The fuel injector of claim 1 wherein said at least one surface is an approximately planar surface aligned along said longitudinal axis.

9. The fuel injector of claim 1 wherein said one surface is an approximately planar surface aligned along said longitudinal axis and wherein said needle valve includes at least one additional planar surface extending along said longitudinal axis.

10. The fuel injector of claim 1 wherein said one surface is an approximately planar surface aligned along said longitudinal axis and wherein said needle valve includes at least two additional planar surface extending along said longitudinal axis.

11. The fuel injector of claim 1 wherein said one surface is an approximately planar surface aligned along said longitudinal axis and wherein said needle valve includes at least four additional planar surface extending along said longitudinal axis.

12. The fuel injector of 1 wherein said one surface is a cylindrical surface aligned with said longitudinal axis.

13. A low pressure fuel injector for delivering fuel to a cylinder of an engine, the fuel injector comprising:
a valve needle having an approximately planar surface extending approximately parallel to a longitudinal axis and a lower surface being approximately planar and extending approximately perpendicular to said longitudinal axis.

14. The fuel injector of claim 13 further including a valve seat defining a valve passage extending along said longitudinal axis and wherein said valve seat defines an inner surface having a first arcuate portion having a profile of an arcuate curve extending from approximate parallel alignment with said longitudinal axis toward said longitudinal axis.

15. The fuel injector of claim 13 further including at least one additional planar surface aligned approximately with said longitudinal axis.

16. The fuel injector of claim 13 further including a valve seat having a first arcuate shape and a second arcuate shape, said first and second arcuate shapes having opposing curves and wherein said second arcuate shape is configured to engage said valve needle to form a valve seal to block the passage of fluid.

17. The fuel injector of claim 13 wherein said valve needle further includes a transition between said approximately planar surface extending approximately parallel to said longitudinal axis and said lower surface and wherein said fuel injector further includes a valve seat, said transition engaging said valve seat.

18. The fuel injector of claim 17 wherein said valve seat includes a first arcuate shape and a second arcuate shapes, wherein said arcuate shapes are approximately opposed, said second arcuate shape engaging said transition to form a valve seal.

19. A low pressure fuel injector for delivering fuel to a cylinder of an engine, the fuel injector comprising:
a valve seat defining a valve passage extending along said longitudinal axis and wherein said valve seat defines an inner surface having a first arcuate portion having a profile of an arcuate curve extending from approximate parallel alignment with said longitudinal axis toward said longitudinal axis, and a second arcuate portion having a substantially opposing arcuate curve.
